(19) United States
(12) Patent Application Publication
(10) Pub. No.: US 2021/0014376 A1
(43) Pub. Date: Jan. 14, 2021

(54) INFORMATION PROCESSING APPARATUS

(71) Applicant: FUJI XEROX CO., LTD., Tokyo (JP)

(72) Inventors: Shinho IKEDA, Kanagawa (JP); Asahito SHIOYASU, Kanagawa (JP); Tomoki TANIHATA, Kanagawa (JP); Hisashi NODA, Kanagawa (JP); Kenta NOMURA, Kanagawa (JP)

(73) Assignee: FUJI XEROX CO., LTD., Tokyo (JP)

(21) Appl. No.: 16/774,150

(22) Filed: Jan. 28, 2020

(30) Foreign Application Priority Data
Jul. 11, 2019 (JP) 2019-129650

(51) Int. Cl. H04N 1/00

(52) U.S. Cl. CPC H04N 1/00928; H04N 1/00933; H04N 1/00899; H04N 1/00907

(57) ABSTRACT

An information processing apparatus includes a first controller that controls an overall operation of the apparatus, and a second controller that outputs an image stored in a specific area of a storage medium to a display device if a predetermined time has elapsed from activation. The second controller generates a second image and writes the second image in the specific area. If a first image is received from the first controller after the second controller writes the second image, the second controller overwrites the second image in the specific area with the first image.

### CROSS-REFERENCE TO RELATED APPLICATIONS

This application is based on and claims priority under 35 USC 119 from Japanese Patent Application No. 2019-129650 filed Jul. 11, 2019.

### BACKGROUND

### (i) Technical Field

The present disclosure relates to an information processing apparatus.

### (ii) Related Art

Image forming apparatuses having a plurality of functions may be provided with a controller that controls an overall operation of a system (hereinafter referred to as “system controller”) and a controller that controls operations of devices (hereinafter referred to as “device controller”). In this configuration, the device controller displays an image generated by the system controller on an operation panel.

Nowadays, the system controller is required to have a function of processing complicated images at high speed. Along with functional sophistication of the system controller, a long time is required to activate the system controller. After the system controller is activated, an interface is initialized to transfer an image generated by the system controller to the device controller. Therefore, it takes a long time to display the image on the operation panel.

Japanese Unexamined Patent Application Publication No. 2016-129945 is an example of related art.

### SUMMARY

Aspects of non-limiting embodiments of the present disclosure relate to the following circumstances. If any abnormality occurs during the activation, the image is not sometimes displayed on the operation panel. Examples of possible causes of failure in image display on the operation panel include an abnormality of activation of the system controller, an abnormality of power supply, and an abnormality of cable connection. However, the cause of failure in image display is not identified if a user only says that the image is not displayed. As a result, initial action becomes late to increase downtime for recovery.

If an abnormality occurs during activation of a first controller that controls an overall operation of an apparatus and an image is not sent from the first controller to a second controller, it is desirable that a display device may display an image for assisting identification of the cause of the abnormality without using a switch for input paths of the image to be displayed on the display device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus comprising a first controller that controls an overall operation of the apparatus, and a second controller that outputs an image stored in a specific area of a storage medium to a display device if a predetermined time has elapsed from activation. The second controller generates a second image and writes the second image in the specific area. If a first image is received from the first controller after the second controller writes the second image, the second controller overwrites the second image in the specific area with the first image.

### BRIEF DESCRIPTION OF THE DRAWINGS

Exemplary embodiments of the present disclosure will be described in detail based on the following figures, wherein:

FIG. 1 illustrates an example of the hardware configuration of an image forming apparatus for use in a first exemplary embodiment;

FIG. 2 illustrates an example of the hardware configurations of a system controller and a device controller;

FIG. 3 illustrates devices and functions related to an operation of activating the image forming apparatus;

FIG. 4 illustrates an overview of an operation of writing display screens 1 and 2 in a page RAM;

FIG. 5 illustrates an example of a writing operation in a case where an operation of activating the system controller is stopped midway due to an abnormality;

FIG. 6 illustrates portions related to six steps in the operation of activating the system controller;

FIG. 7 is a table for describing details of abnormalities and conditions of the system controller in the respective steps;

FIG. 8 illustrates a case where the activation operation proceeds properly in the first exemplary embodiment;

FIG. 9 illustrates a case where the activation operation is stopped due to an abnormality during the activation operation;

FIG. 10 is a table illustrating relationships between display messages and steps in which abnormalities occur;

FIGS. 11A and 11B illustrate specific examples of a message to be displayed on an operation panel, in which FIG. 11A illustrates a display example in which an abnormality occurs in Step #1, and FIG. 11B illustrates a display example in which completion of Step #1 is not reported though power is turned ON;

FIGS. 12A and 12B illustrate other specific examples of the message to be displayed on the operation panel, in which FIG. 12A illustrates a display example in which an abnormality occurs in Step #2, and FIG. 12B illustrates a display example in which an abnormality occurs in Step #5;

FIG. 13 illustrates a case where an activation operation proceeds properly in a second exemplary embodiment;

FIG. 14 illustrates a case where an activation operation proceeds properly in a third exemplary embodiment;

FIG. 15 illustrates a case where an activation operation proceeds properly in a fourth exemplary embodiment; and

FIG. 16 illustrates an activation operation in a fifth exemplary embodiment.

### DETAILED DESCRIPTION

Exemplary embodiments of the present disclosure are described below with reference to the drawings.

### First Exemplary Embodiment

### <Overall Configuration>

In the exemplary embodiments, an image forming apparatus that forms images on recording media such as paper is described as an example of an information processing apparatus. The image forming apparatus of the exemplary embodiments has a function of printing images on paper and a function of reading document images.

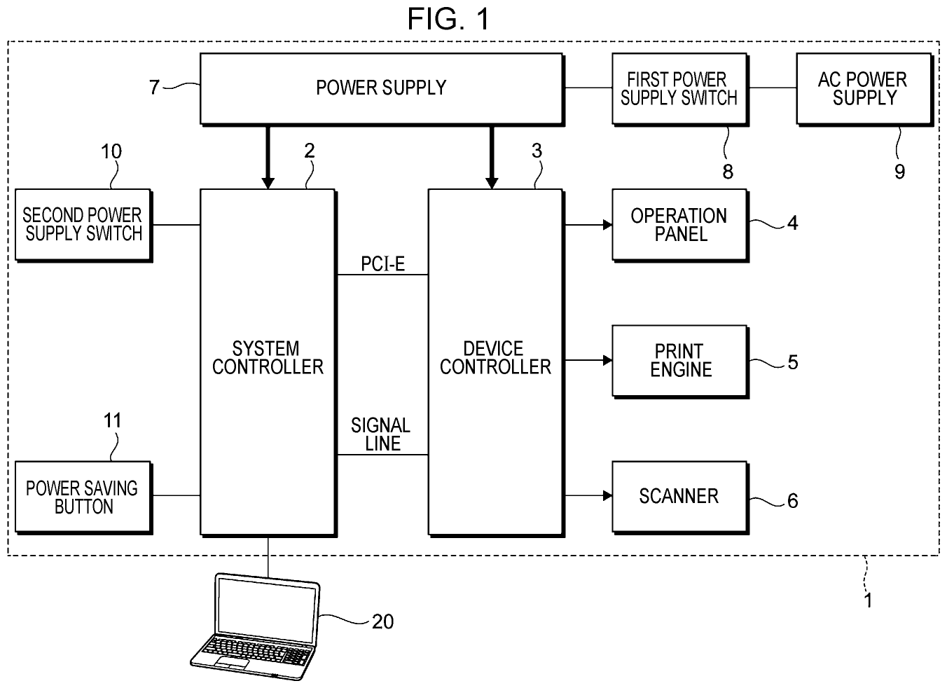

FIG. 1 illustrates an example of the hardware configuration of an image forming apparatus 1 for use in a first exemplary embodiment.

The image forming apparatus 1 illustrated in FIG. 1 includes a system controller 2, a device controller 3, an operation panel 4, a print engine 5, a scanner 6, a power supply 7, a first power supply switch 8, a second power supply switch 10, and a power saving button 11. The system controller 2 controls an overall operation of a system. The device controller 3 controls operations of devices. The operation panel 4 is used for providing information for users and receiving users' operations. The print engine 5 is a machine that executes printing. The scanner 6 reads document images. The power supply 7 supplies electric power to respective parts of the apparatus. The first power supply switch 8 turns ON or OFF the supply of electric power from an alternating current (AC) power supply 9 to the power supply 7. The second power supply switch 10 turns ON or OFF the supply of electric power to mechanical parts or controllers having large power consumption. The power saving button 11 is operated to reduce power consumption on standby.

For example, the operation panel 4 includes a touch panel and various switches and buttons. The touch panel includes a display panel that displays an interface screen, and a touch sensor that detects a user's operation. The display panel is an example of a display device.

The print engine 5 employs an electrophotographic system, an ink jet system, or the like. In the case of the electrophotographic system, the print engine 5 includes a photoconductor, an electrode that charges the photoconductor, a light source for exposure, a developer, a transfer roller, and a fixing roller. In the case of the ink jet system, the print engine 5 includes a head having an array of small-diameter nozzles that eject ink droplets. Examples of the ink jet system include a system in which a head moves in a main scanning direction, and a system in which paper moves in a sub-scanning direction while fixing a head longer than the width of paper in a main scanning direction. The print engine 5 is an example of a machine that prints an image on paper.

The scanner 6 has a mode in which an image is read while moving an optical system relative to a document, and a mode in which an image is read while moving a document relative to a fixed optical system. In this exemplary embodiment, the scanner 6 has an apparatus that automatically transports documents to an image reading position. This apparatus is called an auto document feeder (ADF).

Data stored in a volatile memory (not illustrated) is erased when a predetermined time has elapsed since the first power supply switch 8 was turned OFF, but is not erased even when the second power supply switch 10 or the power saving button 11 is turned OFF.

In FIG. 1, a notebook computer is connected to the image forming apparatus 1 as an external apparatus 20. The external apparatus 20 may be a tablet computer, a desktop computer, or a smartphone. The image forming apparatus 1 and the external apparatus 20 are connected by using Ethernet (registered trademark), a universal serial bus (USB), or Wi-Fi (registered trademark).

### <Configurations of Controllers>

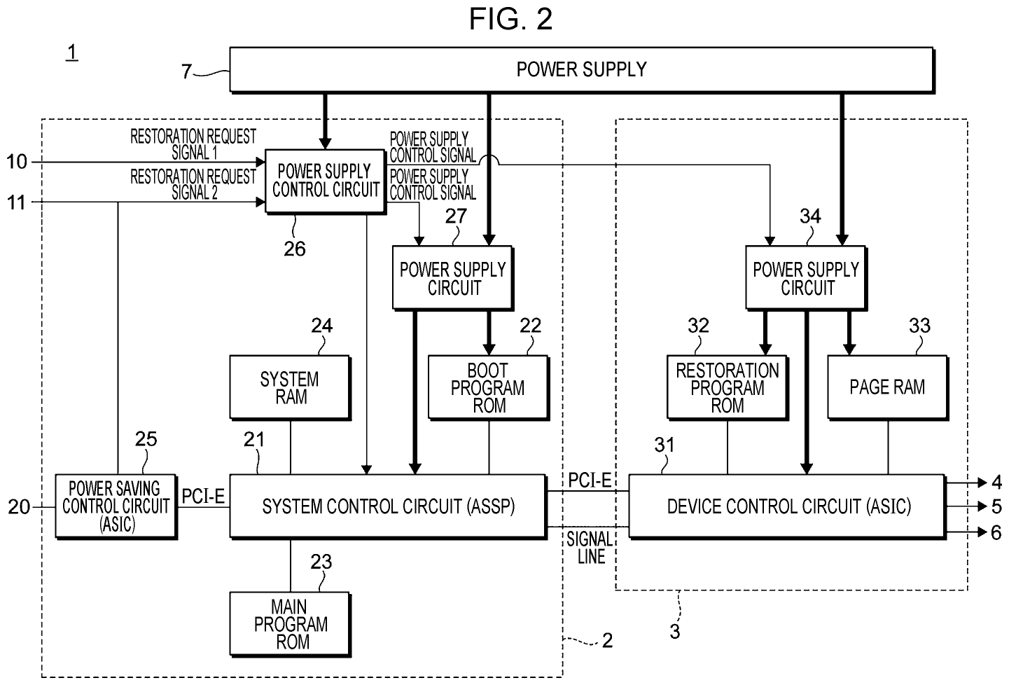

FIG. 2 illustrates an example of the hardware configurations of the system controller 2 and the device controller 3. The system controller 2 is an example of a first controller. The device controller 3 is an example of a second controller.

The system controller 2 includes a system control circuit 21, a boot program read only memory (ROM) 22, a main program ROM 23, a system random access memory (RAM) 24, a power saving control circuit 25, a power supply control circuit 26, and a power supply circuit 27. The system control circuit 21 executes programs. The boot program ROM 22 stores a boot program. The main program ROM 23 stores firmware. The system RAM 24 is used as a working area. The power saving control circuit 25 controls power saving. The power supply control circuit 26 controls power supply by detecting a restoration request signal. The power supply circuit 27 supplies electric power to the system control circuit 21 and the boot program ROM 22.

The system control circuit 21 functions as a CPU that executes the boot program and the firmware. An application specific standard product (ASSP) designed for system control is used as the system control circuit 21.

An application specific integrated circuit (ASIC) designed for power saving control is used as the power saving control circuit 25. The power saving control circuit 25 is connected to the system control circuit 21 via a serial interface. In this exemplary embodiment, Peripheral Component Interconnect Express (PCI-E) is used as the serial interface.

The power supply control circuit 26 receives a restoration request signal 1 output based on a physical position of the second power supply switch 10 and outputs a power supply control signal to the power supply circuit 27 based on a state of the input signal.

The power supply control circuit 26 receives a restoration request signal 2 output based on a physical position of the power saving button 11 and outputs a power supply control signal to the power supply circuit 27 based on a state of the input signal.

The restoration request signal 2 is also output from the power saving control circuit 25. The power saving control circuit 25 outputs the restoration request signal 2 when access from the external apparatus 20 is detected during a power saving mode or a sleep mode. In the sleep mode, power consumption is smaller than in the power saving mode.

The power supply circuit 27 supplies electric power to the system control circuit 21 and the boot program ROM 22 in response to a power supply control signal.

The device controller 3 includes a device control circuit 31, a restoration program ROM 32, a page RAM 33, and a power supply circuit 34. The device control circuit 31 executes a restoration program. The restoration program ROM 32 stores the restoration program. The page RAM 33 is used as a working area. The power supply circuit 34 supplies electric power to the device control circuit 31, the restoration program ROM 32, and the page RAM 33.

The device control circuit 31 functions as a CPU that executes the restoration program. An ASIC designed for device control is used as the device control circuit 31.

The device control circuit 31 is connected to the system control circuit 21 via PCI-E and a signal line. Initialization is necessary for communication via the PCI-E but is not necessary for communication via the signal line. Thus, the system control circuit 21 and the device control circuit 31 communicate with each other via the signal line until initialization of the PCI-E is completed. For example, the signal line is a single metal wire. The signal line is used for communication of two states associated with “1” and “0” or communication of digital signals.

A specific area of the page RAM 33 is secured to store a user interface image (hereinafter referred to also as “UI image”) to be displayed on the operation panel 4.

If the system controller 2 is activated properly, the device control circuit 31 writes a UI image received from the system controller 2 in the specific area of the page RAM 33 and outputs the UI image read from the specific area to the operation panel 4. In the activation operation, the UI image is output to the operation panel 4 after a predetermined time has elapsed or a predetermined number of clocks have been counted from the start of the activation operation. Thus, even if the UI image received from the system control circuit 21 is stored in the page RAM 33, no image is displayed on the operation panel 4 until the predetermined time elapses. That is, even after the second power supply switch 10 is turned ON, a black screen is maintained on the operation panel 4 until the predetermined time elapses.

In this exemplary embodiment, the device control circuit 31 has a function of causing, if the operation of activating the system controller 2 is stopped midway for some reason, the operation panel 4 to display an image that suggests the cause of an abnormality. Specifically, the device control circuit 31 has a function of overwriting an image stored in the specific area of the page RAM 33 every time the device control circuit 31 receives information indicating the status of the operation of activating the system controller 2. Images to be written over the stored image are generated by the device control circuit 31.

It is necessary that the image to be written over the stored image be linked to details of an abnormality in the system controller 2. Although several methods are present to link the image to details of an abnormality, this exemplary embodiment employs a method that involves monitoring reception of a signal indicating the status of the activation operation from the system controller 2 and automatically writing a new image every time the signal reception is detected.

In this case, an image stored in the specific area of the page RAM 33 when the activation operation is stopped is displayed on the operation panel 4 after the predetermined time has elapsed.

If the system controller 2 is activated properly, the image written based on the status of the activation operation is overwritten with the UI image received from the system controller 2. As a result, the UI image received from the system controller 2 is displayed on the operation panel 4 after the predetermined time has elapsed from the start of the activation operation.

The power supply circuit 34 supplies electric power to the device control circuit 31, the restoration program ROM 32, and the page RAM 33 in response to a power supply control signal supplied from the power supply control circuit 26. The power supply circuit 27 is connected to the system control circuit 21 via a serial interface.

### <Devices and Functions Related to Activation Operation>

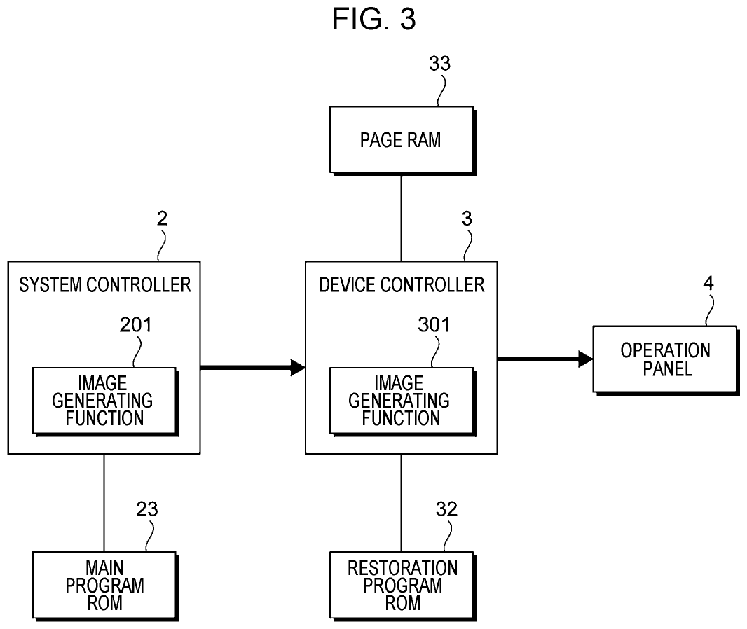

FIG. 3 illustrates devices and functions related to an operation of activating the image forming apparatus 1. For example, the activation operation is executed when the second power supply switch 10 (see FIG. 1) is turned ON while the first power supply switch 8 (see FIG. 1) is ON or when the system is restored from the power saving mode to a normal mode by operating the power saving button 11.

If the operation of activating the system controller 2 is finished properly, the operation panel 4 displays a UI image generated by an image generating function 201 of the system controller 2. The image generating function 201 is a part of a main program. In this exemplary embodiment, the UI image generated by the system controller 2 is referred to as a display screen 1. The display screen 1 is an example of a first image.

If the operation of activating the system controller 2 is stopped midway, the operation panel 4 displays an image generated by an image generating function 301 of the device controller 3. The image generating function 301 is a part of the restoration program. In this exemplary embodiment, the image generated by the device controller 3 is referred to as a display screen 2. The display screen 2 is an example of a second image.

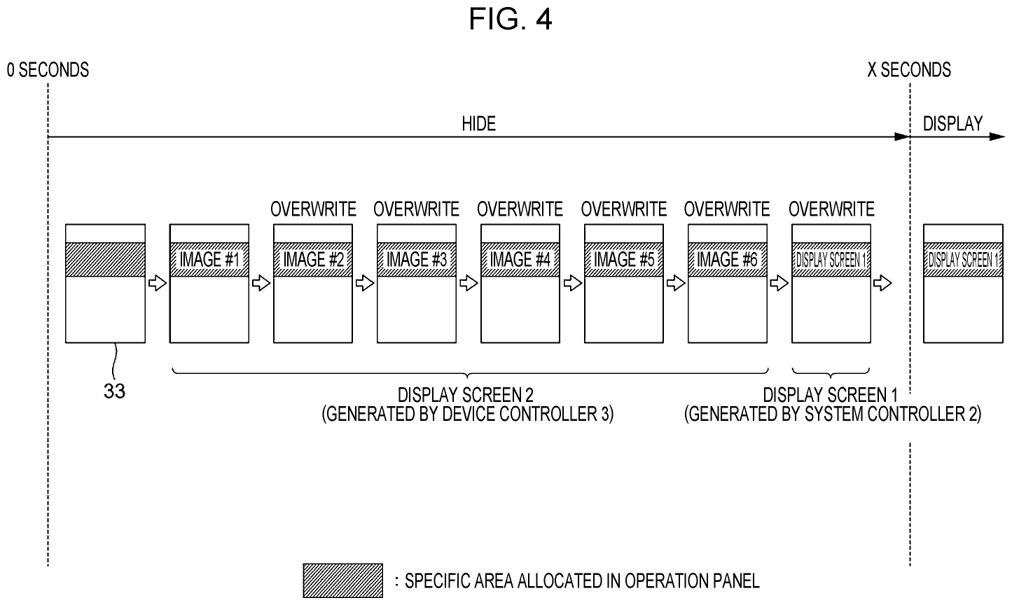

FIG. 4 illustrates an overview of an operation of writing the display screens 1 and 2 in the page RAM 33.

In FIG. 4, the time when the activation operation is started is 0 seconds and the time when an image read from the specific area of the page RAM 33 is displayed on the operation panel 4 (see FIG. 1) is X seconds.

In FIG. 4, the operation of activating the system controller 2 (see FIG. 1) is divided into six steps and an image #1, an image #2, an image #3, an image #4, an image #5, and an image #6 are prepared under the assumption that abnormalities occur in the respective steps. The image #1, the image #2, the image #3, the image #4, the image #5, and the image #6 are examples of the display screen 2.

As illustrated in FIG. 4, no image is stored in the page RAM 33 immediately after the activation operation has been started.

With an elapse of time, the specific area of the page RAM 33 is sequentially overwritten with the image #1, the image #2, the image #3, the image #4, the image #5, and the image #6.

If the system controller 2 is activated properly, the specific area of the page RAM 33 is finally overwritten with the display screen 1 generated by the system controller 2.

In the example of FIG. 4, the display screen 1 is displayed after an elapse of X seconds.

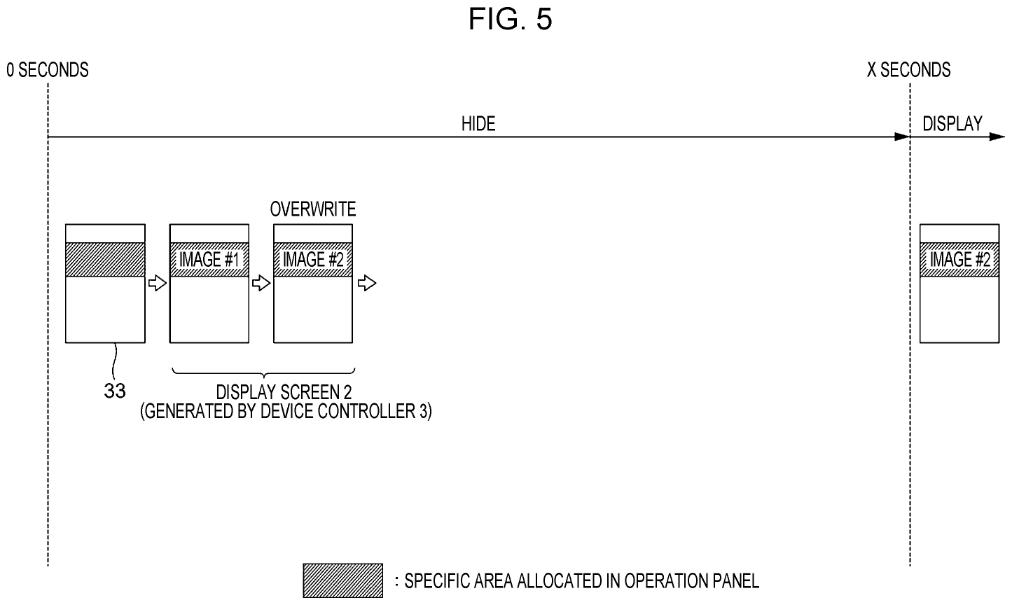

FIG. 5 illustrates an example of a writing operation in a case where the operation of activating the system controller 2 is stopped midway due to an abnormality. In FIG. 5, portions corresponding to those in FIG. 4 are represented by corresponding symbols.

FIG. 5 illustrates an example of an operation in a case where an abnormality occurs in Step #2. Therefore, the specific area of the page RAM 33 is overwritten with the image #2 corresponding to Step #2 and the writing of the display screen 2 is terminated. As a result, the image #2 is displayed after an elapse of X seconds.

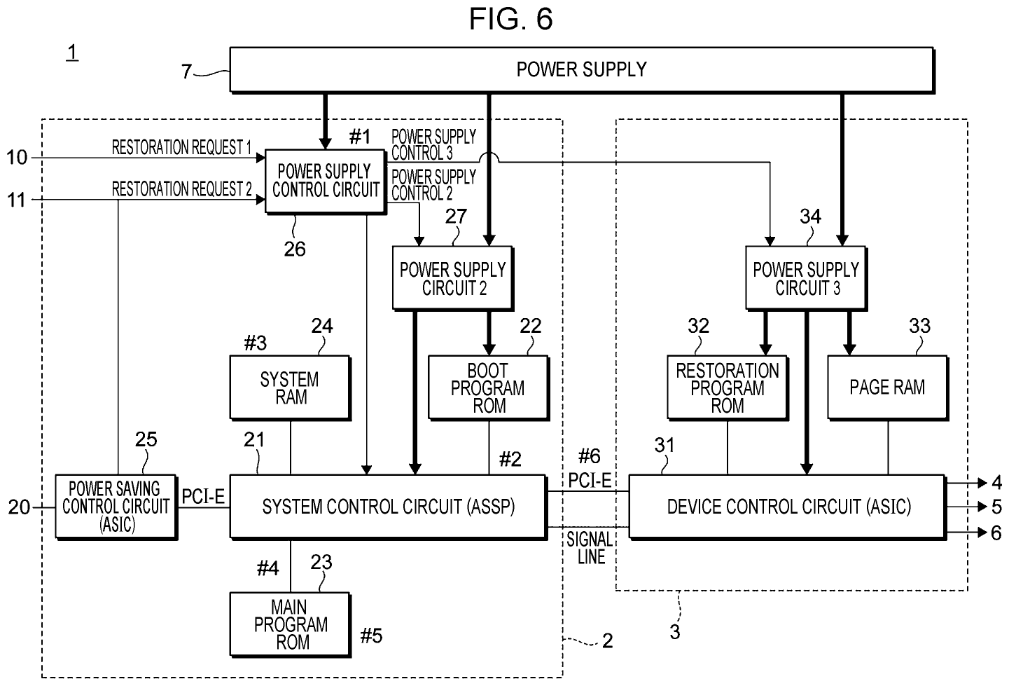

FIG. 6 illustrates portions related to the six steps in the operation of activating the system controller 2.

Step #1 is related to an operation of the power supply control circuit 26.

Step #2 is related to a boot operation of the system control circuit 21.

Step #3 is related to an operation of writing a memory program in the system RAM 24.

Step #4 is related to execution of the main program.

Step #5 is related to execution of a high-speed restoration program.

Step #6 is related to a communication operation between the system controller 2 and the device controller 3.

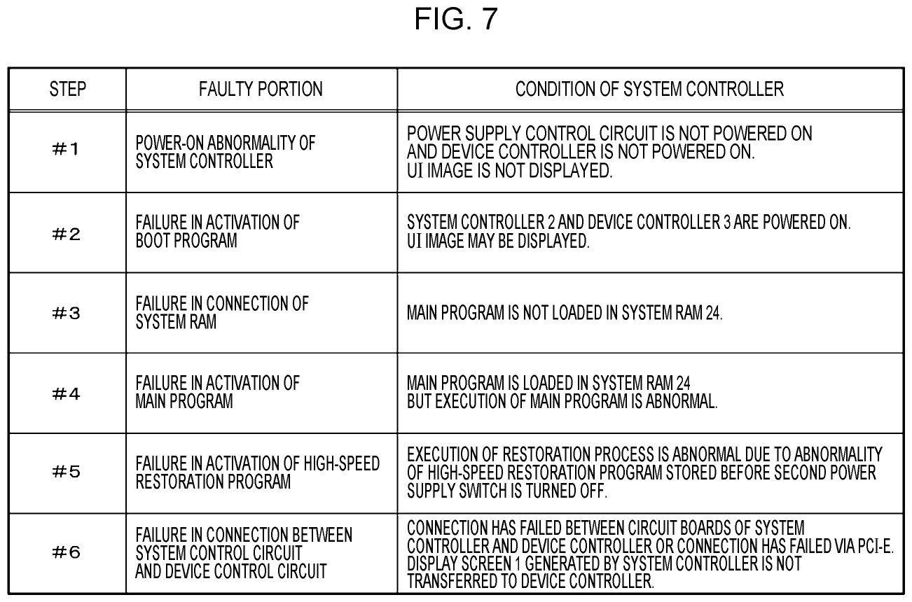

FIG. 7 is a table for describing details of abnormalities and conditions of the system controller 2 in the respective steps.

The abnormality of Step #1 is a power-on abnormality of the system controller 2. In the event of this abnormality, the power supply control circuit 26 is not powered ON and the device controller 3 is not powered ON. Therefore, the UI image is not displayed.

The abnormality of Step #2 is failure in activation of the boot program. In the event of this abnormality, the system controller 2 and the device controller 3 are powered ON. The UI image may be displayed.

The abnormality of Step #3 is failure in connection of the system RAM 24. In the event of this abnormality, the main program is not loaded in the system RAM 24.

The abnormality of Step #4 is failure in activation of the main program. In the event of this abnormality, the main program is loaded in the system RAM 24 but execution of the main program is abnormal.

The abnormality of Step #5 is failure in activation of the high-speed restoration program. In the event of this abnormality, execution of a restoration process is abnormal due to an abnormality of the high-speed restoration program stored before the second power supply switch 10 is turned OFF.

The abnormality of Step #6 is failure in connection between the system control circuit 21 and the device control circuit 31. In the event of this abnormality, connection has failed between circuit boards of the system controller 2 and the device controller 3 or connection has failed via the PCI-E. The display screen 1 generated by the system controller 2 is not transferred to the device controller 3.

### <Activation Operation>

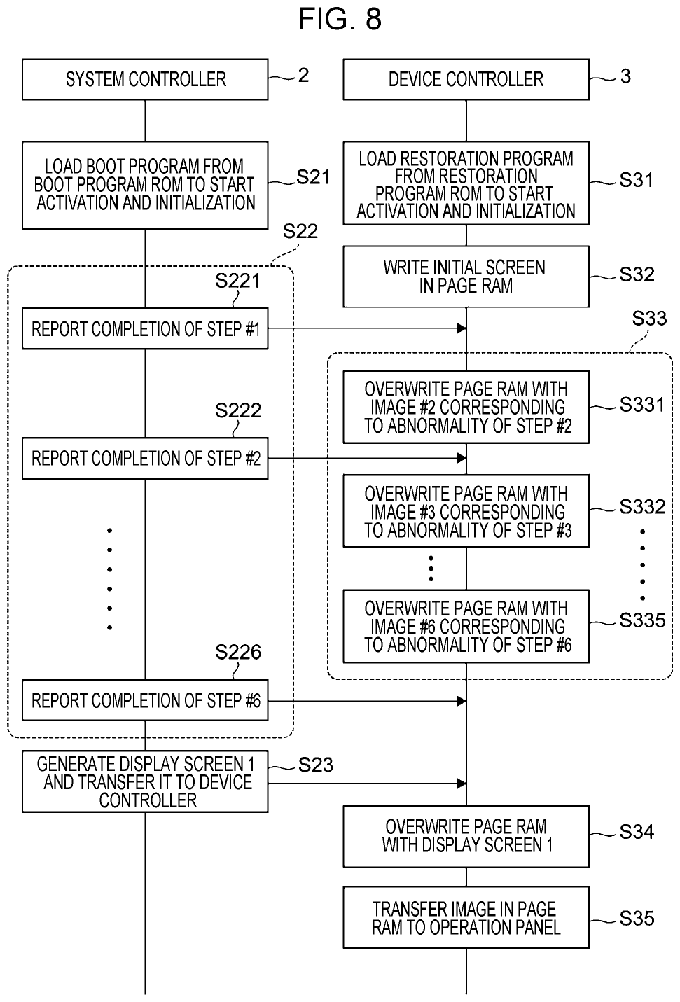

FIG. 8 illustrates a case where the activation operation proceeds properly in the first exemplary embodiment. The symbol “S” in FIG. 8 represents “step”.

For example, the activation operation is started when a user turns ON the second power supply switch 10. The operation of activating the system controller 2 and the device controller 3 is started under the condition that electric power is supplied properly. If electric power is not supplied properly, an abnormality occurs in Step #1.

If electric power is supplied properly, the system control circuit 21 of the system controller 2 loads the boot program from the boot program ROM 22 to start activation and initialization (Step 21). The device control circuit 31 of the device controller 3 loads the restoration program from the restoration program ROM 32 to start activation and initialization (Step 31). The device control circuit 31 writes an initial screen in the page RAM 33 (Step 32).

Every time completion of a step in the activation operation is detected, the system control circuit 21 of the system controller 2 reports the completion of the step to the device control circuit 31 of the device controller 3 (Step 22). The signal line is used for the reporting.

If the operation of activating the system controller 2 proceeds properly, completion of each step is reported in the order of Step 221, Step 222, . . . and Step 226. In this exemplary embodiment, the report is represented by “123-00N”, provided that the number of a completed step is “#N”.

Every time completion of a step is reported, the device control circuit 31 of the device controller 3 overwrites the page RAM 33 with an image including details of an abnormality and appropriate action of the user under the assumption that the activation operation may be stopped in a step next to the reported step (Step 33).

For example, in response to the report on the completion of Step #1, the device control circuit 31 overwrites the page RAM 33 with the image #2 corresponding to the abnormality of Step #2 (Step 331).

In response to the report on the completion of Step #2, the device control circuit 31 overwrites the page RAM 33 with the image #3 corresponding to the abnormality of Step #3 (Step 332).

In response to the report on the completion of Step #3, the device control circuit 31 overwrites the page RAM 33 with the image #4 corresponding to the abnormality of Step #3.

In response to the report on the completion of Step #4, the device control circuit 31 overwrites the page RAM 33 with the image #5 corresponding to the abnormality of Step #5.

In response to the report on the completion of Step #5, the device control circuit 31 overwrites the page RAM 33 with the image #6 corresponding to the abnormality of Step #6 (Step 335).

In this exemplary embodiment, the device control circuit 31 overwrites each stored image under the condition that a report is received. The device control circuit 31 does not check details.

The image #1 corresponding to the abnormality of Step #1 is not written in the page RAM 33. This is because the abnormality of Step #1 is the power-on abnormality and the device controller 3 does not operate.

The reason why an image showing details of an abnormality and the like in a step next to the reported step is written in the page RAM 33 is that, if the activation operation is stopped in the next step, the device control circuit 31 does not receive a report on completion of the step in which the abnormality occurs.

In FIG. 8, the operation of activating the system controller 2 proceeds properly. Therefore, the system control circuit 21 of the system controller 2 generates a display screen 1 and transfers the display screen 1 to the device controller 3 when Step #6 is completed (Step 23).

In response to reception of the display screen 1, the device control circuit 31 of the device controller 3 overwrites the page RAM 33 with the received display screen (Step 34). As a result, only the display screen 1 is present in the specific area of the page RAM 33.

Then, the device control circuit 31 of the device controller 3 transfers the image in the page RAM 33 to the operation panel 4 (Step 35). As a result, the operation panel 4 displays the display screen 1 generated by the system controller 2.

The activation operation illustrated in FIG. 8 corresponds to the operation described with reference to FIG. 4.

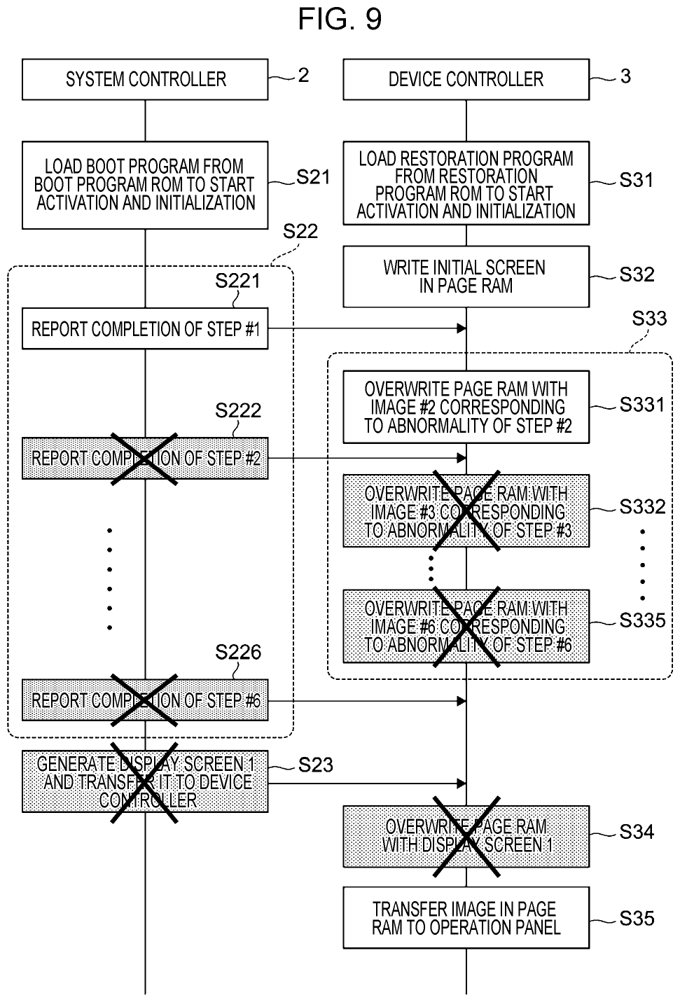

FIG. 9 illustrates a case where the activation operation is stopped due to an abnormality during the activation operation. In FIG. 9, portions corresponding to those in FIG. 8 are represented by corresponding symbols.

FIG. 9 illustrates an example in which the activation operation is stopped in Step #2. In this case, only the completion of Step #1 is reported to the device controller 3. Therefore, the initially written image #2 corresponding to the abnormality of Step #2 is transferred to the operation panel 4.

The activation operation illustrated in FIG. 9 corresponds to the operation described with reference to FIG. 5.

### Examples of Display Screen

Specific examples of the display screen 2 to be displayed on the operation panel 4 are described below.

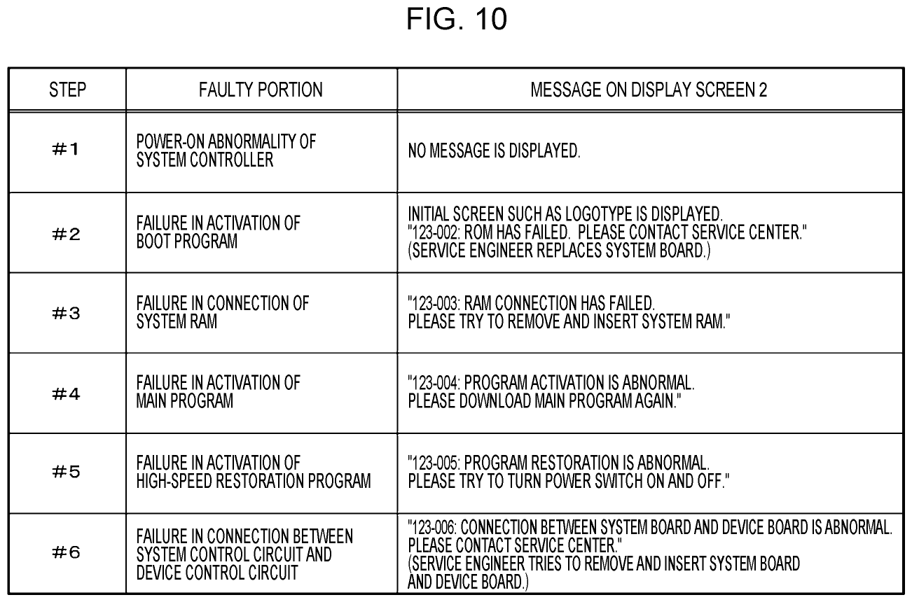

FIG. 10 is a table illustrating relationships between display messages and steps in which abnormalities occur.

There is no display message corresponding to the abnormality of Step #1. This is because the abnormality of Step #1 is the power-on abnormality and the device controller 3 does not operate.

As a display message corresponding to the abnormality of Step #2, an initial screen such as a logotype is displayed. For example, the display message reads “123-002: ROM HAS FAILED. PLEASE CONTACT SERVICE CENTER.” In this case, a service engineer replaces a system board.

For example, a display message corresponding to the abnormality of Step #3 reads “123-003: RAM CONNECTION HAS FAILED. PLEASE TRY TO REMOVE AND INSERT SYSTEM RAM.”

For example, a display message corresponding to the abnormality of Step #4 reads “123-004: PROGRAM ACTIVATION IS ABNORMAL. PLEASE DOWNLOAD MAIN PROGRAM AGAIN.”

For example, a display message corresponding to the abnormality of Step #5 reads “123-005: PROGRAM RESTORATION IS ABNORMAL. PLEASE TRY TO TURN POWER SWITCH ON AND OFF.”

For example, a display message corresponding to the abnormality of Step #6 reads “123-006: CONNECTION BETWEEN SYSTEM BOARD AND DEVICE BOARD IS ABNORMAL. PLEASE CONTACT SERVICE CENTER.” In this case, a service engineer tries to remove and insert the system board and the device board.

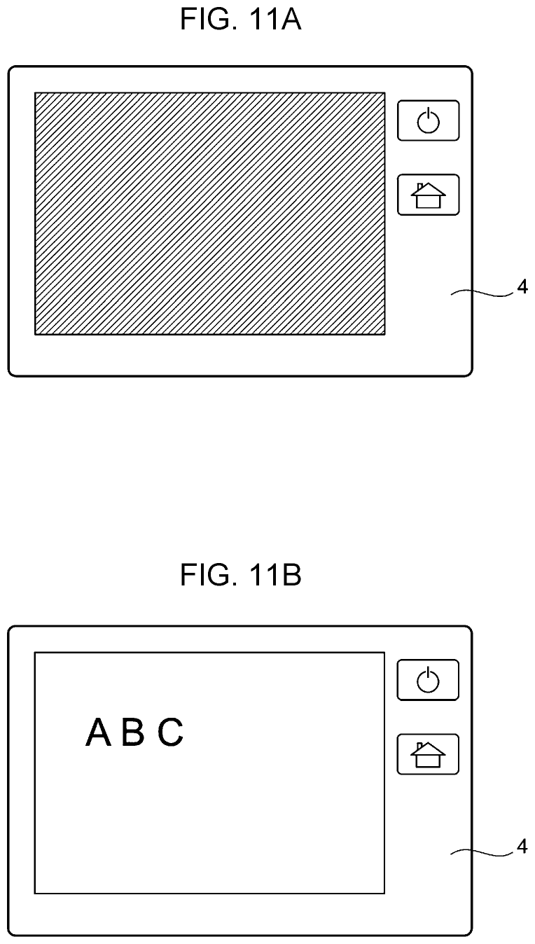

FIGS. 11A and 11B illustrate specific examples of the message to be displayed on the operation panel. FIG. 11A illustrates a display example in which an abnormality occurs in Step #1. FIG. 11B illustrates a display example in which completion of Step #1 is not reported though power is turned ON.

The abnormality of Step #1 is an abnormality of the power supply control circuit 26. Therefore, no message is displayed on the operation panel 4 as illustrated in FIG. 11A. Since the screen is not displayed though the second power supply switch 10 (see FIG. 2) is turned ON, electric power is not supplied or an abnormality occurs in the operation panel 4 or in the connection to the operation panel 4.

When the completion of Step #1 is not reported, an initial screen written in the page RAM 33 when power is turned ON is directly displayed on the operation panel 4. When the initial screen is displayed, electric power is supplied and the connection between the device control circuit 31 and the operation panel 4 is normal.

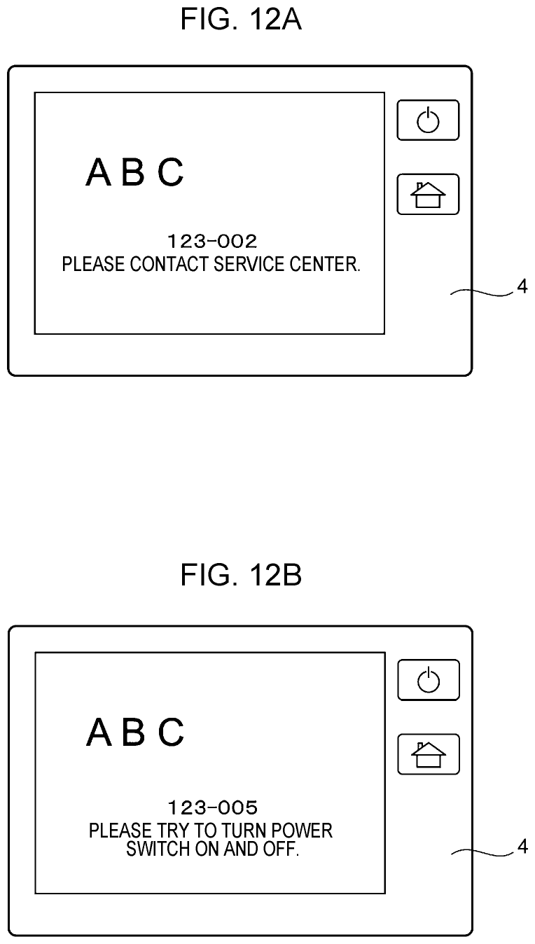

FIGS. 12A and 12B illustrate other specific examples of the message to be displayed on the operation panel. FIG. 12A illustrates a display example in which an abnormality occurs in Step #2. FIG. 12B illustrates a display example in which an abnormality occurs in Step #5.

The abnormality of Step #2 is failure in activation of the boot program. In this case, completion of Step #1 is reported to the device control circuit 31 but completion of Step #2 is not reported to the device control circuit 31. Therefore, the update of an image stored in the page RAM 33 is stopped at the image showing the abnormality of Step #2. Thus, the operation panel 4 displays details of the abnormality of Step #2.

The abnormality of Step #5 is failure in activation of the high-speed restoration program. In this case, completion of Step #4 is reported but completion of Step #5 is not reported. Therefore, the update of an image stored in the page RAM 33 is stopped at the image showing the abnormality of Step #5. Thus, the operation panel 4 displays details of the abnormality of Step #5.

As described above, this exemplary embodiment employs the method that involves automatically writing, in response to reports on completion of steps, images showing details of abnormalities of the steps in the page RAM 33 in predetermined order.

In this exemplary embodiment, images prepared in advance are simply written over the specific area of the page RAM 33 sequentially based on the status of the operation of activating the system controller 2. If the activation operation is stopped midway, an image written in the page RAM 33 at that time is displayed on the operation panel 4 after the predetermined time has elapsed.

### Second Exemplary Embodiment

In the exemplary embodiment described above, the images prepared in advance are sequentially read and written over the specific area of the page RAM 33 without checking details of reports on completion from the system controller 2. Details of reports may be checked and an image to be written in the specific area of the page RAM 33 may be determined based on the checked details.

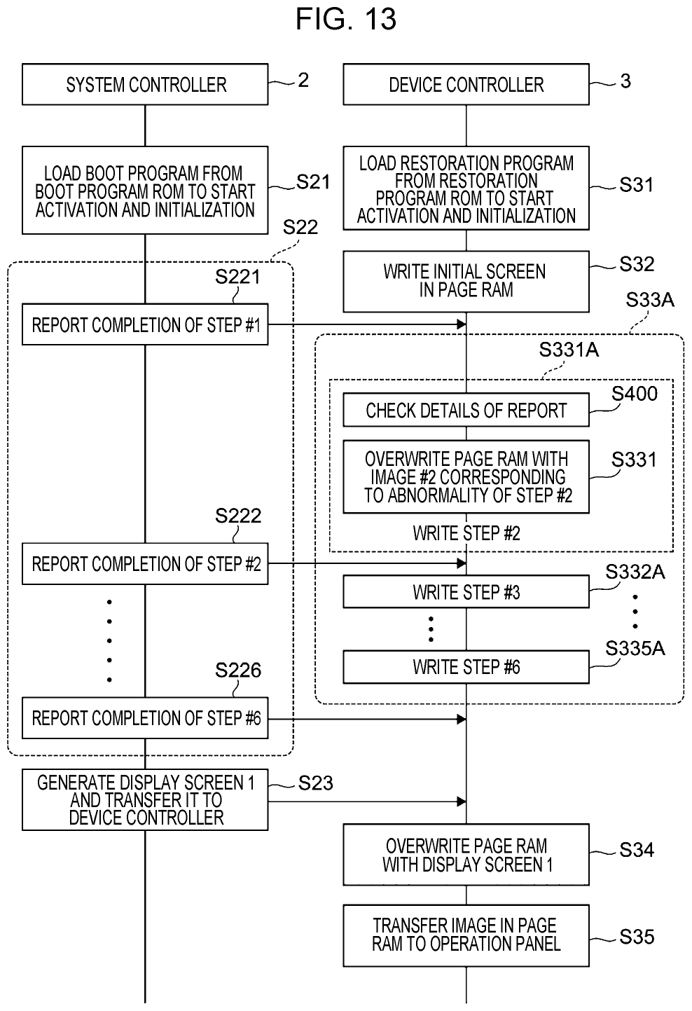

FIG. 13 illustrates a case where an activation operation proceeds properly in a second exemplary embodiment. In FIG. 13, portions corresponding to those in FIG. 8 are represented by corresponding symbols.

In FIG. 13, every time completion of a step is reported, details of the report are checked (Step 400) and the page RAM 33 is overwritten with an image corresponding to a step next to the step whose completion is checked.

For example, in response to a report on completion of Step #1, the device controller 3 executes Step 331A including the two processes in combination.

In response to a report on completion of Step #2, the device controller 3 executes Step 332A. In response to a report on completion of Step #3, the device controller 3 executes Step 333A (not illustrated). In response to a report on completion of Step #4, the device controller 3 executes Step 334A (not illustrated). In response to a report on completion of Step #5, the device controller 3 executes Step 335A.

In this exemplary embodiment, the status of the operation of activating the system controller 2 is checked and an image to be written in the specific area of the page RAM 33 is determined (Step 33A).

### Third Exemplary Embodiment

In the exemplary embodiments described above, every time completion is reported from the system controller 2, an image showing details of an abnormality of a next step is written over the specific area of the page RAM 33. The image may be written only once at a predetermined time point from the start of the activation operation.

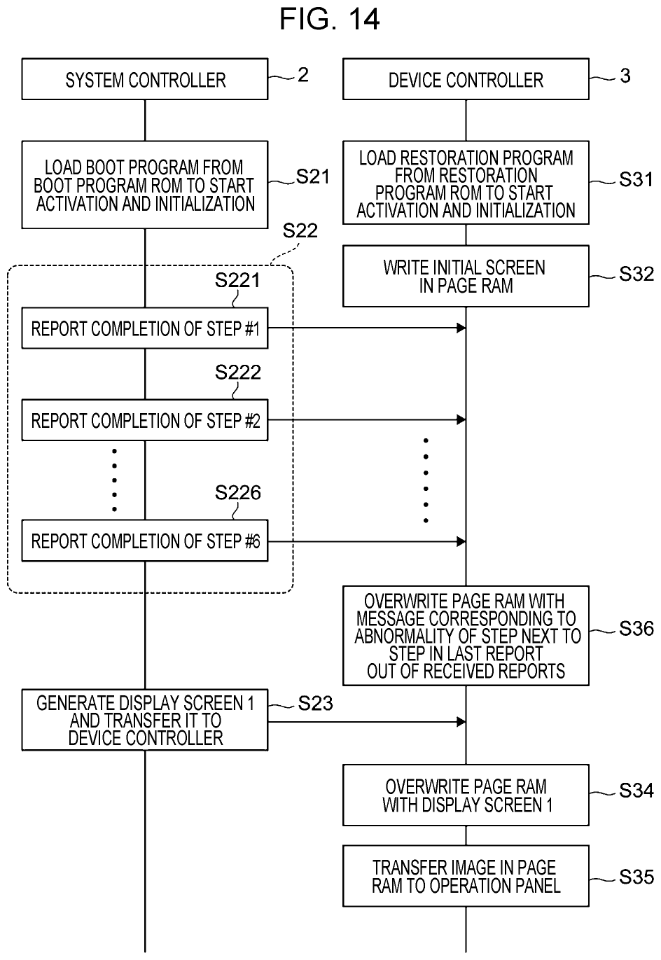

FIG. 14 illustrates a case where an activation operation proceeds properly in a third exemplary embodiment. In FIG. 14, portions corresponding to those in FIG. 8 are represented by corresponding symbols.

In FIG. 14, the page RAM 33 is overwritten with a message corresponding to an abnormality of a step next to a step in the last report out of received reports at the predetermined time point from the start of the activation operation (Step 36).

The overwriting in Step 36 is scheduled so that the overwriting is completed earlier than the timing when the page RAM 33 is overwritten with the display screen 1 transferred from the system controller 2 if the operation of activating the system controller 2 proceeds properly (Step 34).

If completion of Step #1 is not reported, an initial screen is written in the page RAM 33.

As in the second exemplary embodiment, the process of checking details of reports may be performed in combination.

### Fourth Exemplary Embodiment

In the exemplary embodiments described above, completion of each step is reported from the system controller 2. Details of an abnormality may be reported and an image corresponding to the reported details of the abnormality may be written in the specific area of the page RAM 33.

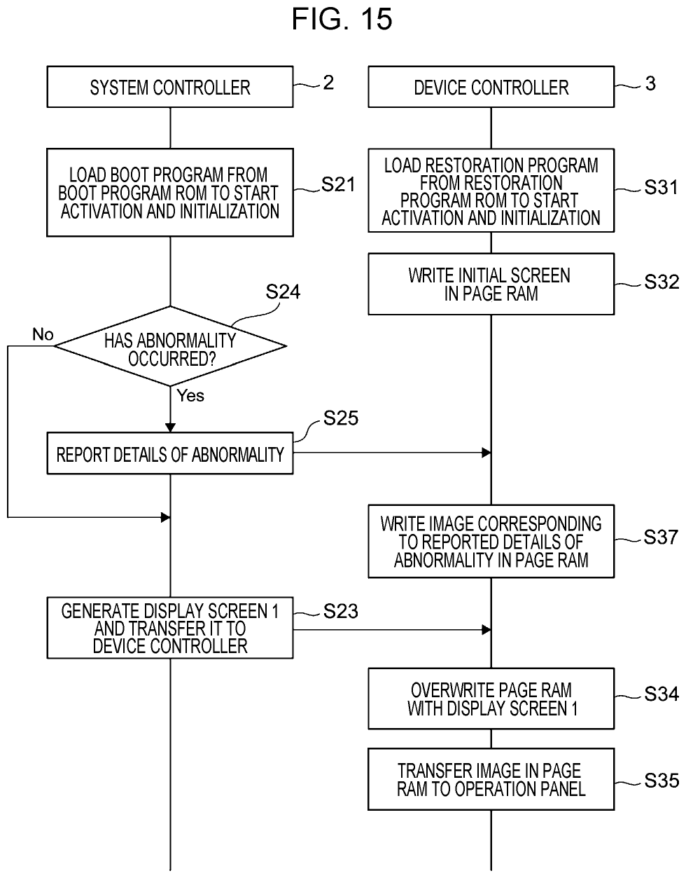

FIG. 15 illustrates a case where an activation operation proceeds properly in a fourth exemplary embodiment. In FIG. 15, portions corresponding to those in FIG. 8 are represented by corresponding symbols.

In FIG. 15, the system controller 2 determines whether an abnormality occurs during the activation operation (Step 24). If an abnormality occurs before the six steps are completed, the system controller 2 obtains a positive result in Step 24.

If the positive result is obtained in Step 24, the system controller 2 reports details of the abnormality to the device controller 3 (Step 25). The signal line is used for reporting the details of the abnormality. In this case, the device controller 3 writes an image corresponding to the reported details of the abnormality in the page RAM 33 (Step 37).

If a negative result is obtained in Step 24, the system controller 2 generates a display screen 1 and transfers the display screen 1 to the device controller 3 (Step 23).

The subsequent operation is identical to that of the first exemplary embodiment.

### Fifth Exemplary Embodiment

In the fourth exemplary embodiment, in response to a report on an abnormality, the device controller 3 writes an image corresponding to the reported details of the abnormality in the page RAM 33. An image corresponding to a step that is being executed depending on the length of an elapsed time from activation may automatically be written in the page RAM 33 and the update of the image may be stopped if an abnormality is reported before all the steps are completed.

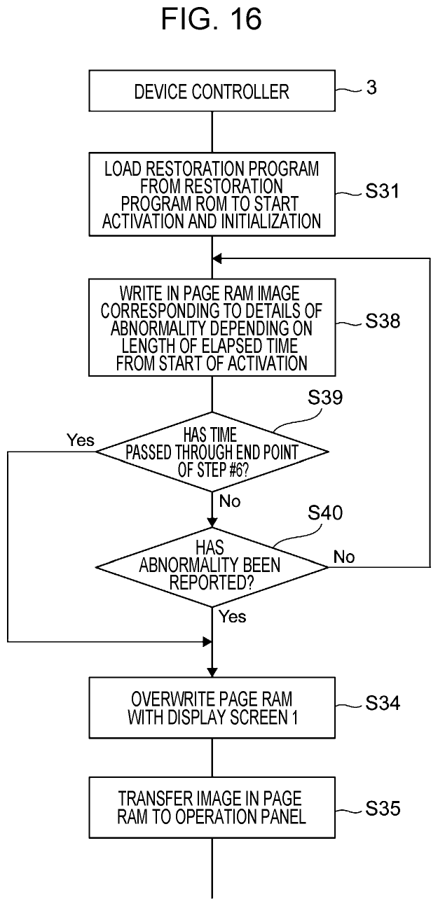

FIG. 16 illustrates an activation operation in a fifth exemplary embodiment. In FIG. 16, portions corresponding to those in FIG. 8 are represented by corresponding symbols. FIG. 16 only illustrates an activation operation in the device controller 3. An activation operation in the system controller 2 is similar to that in FIG. 15.

As illustrated in FIG. 16, the device controller 3 of this exemplary embodiment automatically writes, in the page RAM 33, an image corresponding to details of an abnormality depending on the length of an elapsed time from the start of activation (Step 38). That is, the device controller 3 of this exemplary embodiment measures a time from the start of the activation operation.

The device controller 3 of this exemplary embodiment stores a table that records relationships between the measured time and each step that is being executed in the system controller 2. Therefore, the device controller 3 alone may write an image corresponding to each step.

If the elapse of time is the only reference, however, the writing in the page RAM 33 is not stopped even though an abnormality occurs in the operation of activating the system controller 2.

The device controller 3 of this exemplary embodiment makes the following determinations.

First, the device controller 3 determines whether the time has passed through the end point of Step #6 (Step 39).

If a negative result is obtained in Step 39, the device controller 3 determines whether an abnormality is reported from the system controller 2 (Step 40).

If a negative result is obtained in Step 40, the device controller 3 returns to the process of Step 38 and overwrites the page RAM 33 with an image corresponding to a next step.

If a negative result is obtained in Step 39 and a positive result is obtained in Step 40, that is, if an abnormality is reported before the time passes through the end point of Step #6, the device controller 3 exits from the loop for returning to Step 38. By exiting from the loop for returning to Step 38, the update of the image in the page RAM 33 with the elapse of time is stopped.

If the time has passed through the end point of Step #6 without receiving a report on an abnormality, the device controller 3 obtains a positive result in Step 39 and exits from the loop for returning to Step 38.

The subsequent operation is identical to that of the first exemplary embodiment.

In FIG. 16, determination is made, in Step 40, whether an abnormality is reported, but determination may be made whether completion of each step is reported in a predetermined time. In this determination, the process returns to Step 38 if completion of each step is reported in the predetermined time, and the process proceeds to Step 34 if completion of each step is not reported in the predetermined time.

### Other Exemplary Embodiments

In the exemplary embodiments described above, the image forming apparatus 1 (see FIG. 1) is described as an example of the information processing apparatus. The information processing apparatus is applicable to any apparatus including a CPU that controls an overall operation of a system and a CPU that controls operations of devices and having a power saving mode. The number of steps in the activation operation varies depending on the applied apparatus.

In the exemplary embodiments described above, the image forming apparatus 1 has a plurality of functions. The information processing apparatus may specialize in a specific function. For example, the information processing apparatus may be a printer or a scanner having a single function.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus, comprising:
a first controller that controls an overall operation of the apparatus; and
a second controller that outputs an image stored in a specific area of a storage medium to a display device if a predetermined time has elapsed from activation,
wherein the second controller generates a second image and writes the second image in the specific area, and
wherein, if a first image is received from the first controller after the second controller writes the second image, the second controller overwrites the second image in the specific area with the first image.

2. The information processing apparatus according to claim 1, wherein the second controller monitors reception of a signal indicating a status of activation of the first controller, and determines the second image to be written in the specific area.

3. The information processing apparatus according to claim 2, wherein the second controller updates the second image in the specific area every time the first controller updates the signal indicating the status of the activation.

4. The information processing apparatus according to claim 3, wherein, if the first controller stops updating the signal indicating the status of the activation, the second controller outputs the second image written in the specific area to the display device after the predetermined time has elapsed from the activation.

5. The information processing apparatus according to claim 1, wherein the second controller writes the second image in the specific area based on contents of a signal indicating a status of activation of the first controller.

6. The information processing apparatus according to claim 5, wherein the second controller updates the second image in the specific area every time the contents of the signal are updated.

7. The information processing apparatus according to claim 5, wherein the second controller writes the second image in the specific area only once based on contents of the signal received last.

8. The information processing apparatus according to claim 1, wherein the second image comprises information for identifying details of a malfunction in the first controller.

9. The information processing apparatus according to claim 1, wherein the second image comprises details of appropriate action to be taken by a user to eliminate a malfunction.

10. The information processing apparatus according to claim 1, wherein the second controller updates the second image based on a length of an elapsed time from the activation.

11. The information processing apparatus according to claim 10, wherein the second image written in the specific area by the second controller is an image associated with the length of the elapsed time from the activation.

12. The information processing apparatus according to claim 11, wherein the second controller stops updating the second image in response to a report from the first controller about a malfunction during the activation.

13. An information processing apparatus, comprising:
first control means for controlling an overall operation of the apparatus; and
second control means for outputting an image stored in a specific area of a storage medium to a display device if a predetermined time has elapsed from activation,
wherein the second control means generates a second image and writes the second image in the specific area, and
wherein, if a first image is received from the first control means after the second control means writes the second image, the second control means overwrites the second image in the specific area with the first image.
